(19) United States
(12) Patent Application Publication
(10) Pub. No.: US 2021/0153477 A1
(43) Pub. Date: May 27, 2021

(54) PET LEASH WITH BALL LAUNCHER

(71) Applicant: Peter Wilhelm Emblad, Mill Valley, CA (US)

(72) Inventor: Peter Wilhelm Emblad, Mill Valley, CA (US)

(21) Appl. No.: 16/949,977

(22) Filed: Nov. 23, 2020

Related U.S. Application Data
(60) Provisional application No. 62/939,462, filed on Nov. 22, 2019.

(51) Int. Cl. A01K 27/00; A01K 15/02

(52) U.S. Cl. CPC A01K 27/003; A01K 15/02

(57) ABSTRACT

A pet accessory comprising a leash and a receptacle for holding a spherical object is provided. The pet accessory provides a combination pet leash and sling for holding the spherical object which may also be used as a sling to hurl the object. The pet accessory comprising a leash, a sling system and a spherical object receptacle built into the pet accessory is capable of use to hurl a projectile easily without a separate accessory.

### CROSS-REFERENCE TO RELATED APPLICATION

This application claims the benefit of priority of U.S. provisional application No. 62/939,462, filed 22 Nov. 2019, the contents of which are herein incorporated by reference.

### BACKGROUND OF THE INVENTION

The present invention relates to pet accessories, and more particularly to a pet accessory comprising a pet leash and a projectile launcher. More particularly, the pet accessory may comprise a pet leash and a receptacle for holding a spherical object such that the leash may be used to retain the object, and may further be used as a sling by which the object may be hurled.

Dogs and other pets often enjoy chasing after balls and other objects thrown by individuals. Some individuals have difficulty throwing projectiles a significant distance due to musculoskeletal discomfort.

Hurling a ball with just your arm hurts your shoulder and elbow. The only device commercially available for hurling a ball with assistance is the “ChuckIt”, which is a separate device that is an accessory which must be carried by the user, and is not always readily available.

As can be seen, there is a need for a unitary sling system which is capable not only of retaining the spherical object, but also of use in hurling a projectile easily without the need of a separate accessory.

In addition, there is a need for a device which may provide additional functions and capabilities.

Accordingly, there is a need for a solution to at least one of the aforementioned problems.

### SUMMARY OF THE INVENTION

In one aspect of the present invention, a pet accessory includes the following: a leash, and a receptacle for holding a spherical object.

In another aspect of the present invention, a pet accessory provides a combination pet leash and sling for holding a spherical object which may also be used as a sling to hurl the object.

In yet another aspect of the present invention, a pet accessory comprising a leash, a sling system and a spherical object receptacle built into the pet accessory is capable of use to hurl a projectile easily without a separate accessory.

In a still further aspect of the present invention, a pet accessory provides a solution to the following problems: providing a leash, providing a receptacle for holding a spherical object, providing a projectile launcher for launching the spherical object, and providing a unitary assembly for a multipurpose pet accessory.

These and other features, aspects and advantages of the present invention will become better understood with reference to the following drawings, description and claims.

### BRIEF DESCRIPTION OF THE DRAWINGS

The preferred embodiment of the claimed subject matter will hereinafter be described in conjunction with the appended drawings provided to illustrate and not to limit the scope of the claimed subject matter, where like designations denote like elements, and in which:

FIG. 1 presents a perspective view of an exemplary embodiment of the present invention in use as a leash;

FIG. 2 presents a top plan view of an exemplary embodiment of the present invention;

FIG. 3 presents a detail view taken along line 3-3 of FIG. 2, enlarged to show detail;

FIG. 4 presents a side elevation view of an exemplary embodiment of the present invention in use as a ball launcher; and

FIG. 5 presents a detail view taken along line 5-5 of FIG. 4, enlarged to show detail.

It is to be understood that like reference numerals refer to like parts throughout the several views of the drawings.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

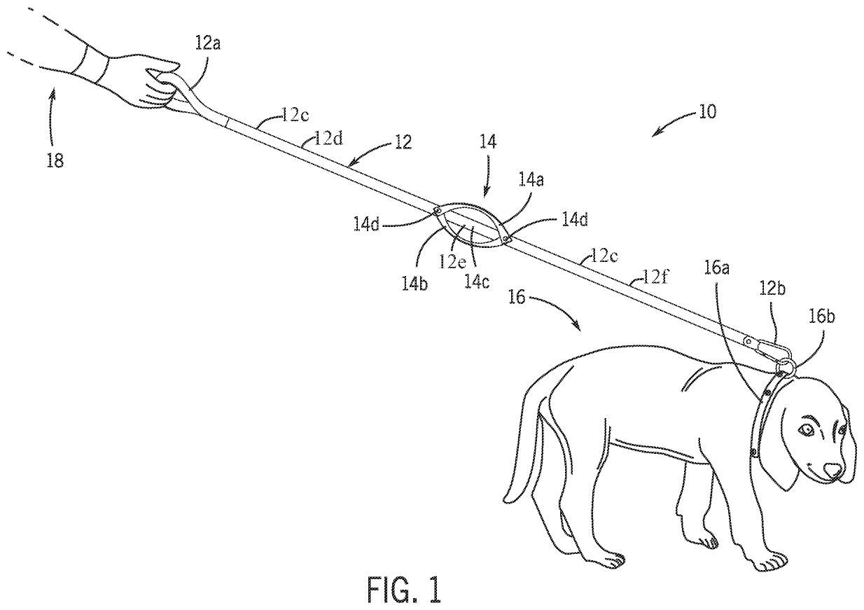

As used herein, “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, as there is no intention to be bound by any express or implied theory presented in the preceding technical field, background, brief summary or the following detailed description, it is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Broadly, one embodiment of the present invention is a multipurpose pet accessory which provides a pet leash and a sling assembly. The pet accessory may be used as a pet leash for attachment to a dog collar. The sling assembly may be used to retain a round object such as a ball when the leash is in use, and may be when removed from the leash, be used as a projectile launcher to launch the round object.

As noted hereinabove, dogs and other pets often enjoy chasing after balls and other objects thrown by individuals. The present invention provides a multipurpose pet accessory which meets important needs. Some individuals have difficulty throwing projectiles a significant distance due to musculoskeletal discomfort. Hurling a ball with just the arm may injure the shoulder and elbow. Separate devices which must be carried by the user and are not always readily available, are disadvantageous.

Advantageously, the present invention provides a solution with a multipurpose pet accessory comprising a sling system and spherical object receptacle built into a leash which allows for the ability to hurl a projectile easily without an additional accessory.

The present invention provides a sling incorporated into a leash which may allow the individual to hurl a spherical object a substantial distance without injuring the individual's joints and muscles, and hurl the object farther than possible with the arm alone.

The present invention differs from and distinguishes over what currently exists. Current options are separate devices which are cumbersome and need to be transported with the user, and further are not always readily available. In accordance with the present invention, a sling built into a leash provides the capability of hurling of spherical projectiles with the convenience of always having the ability built into the leash already with the user. The present invention provides a sling and spherical object receptacle built into the leash which allows for the ability to hurl a projectile easily without an accessory object.

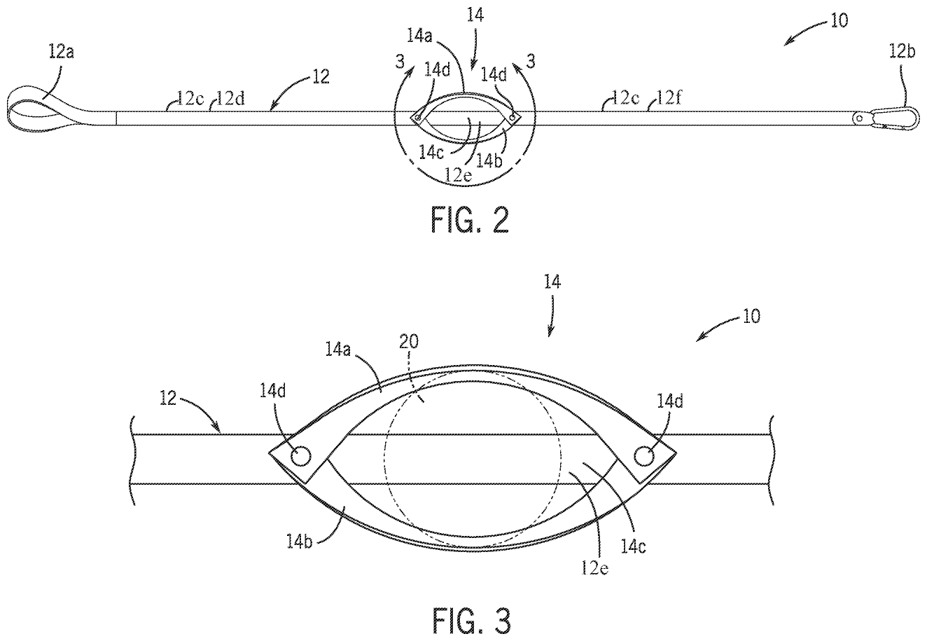

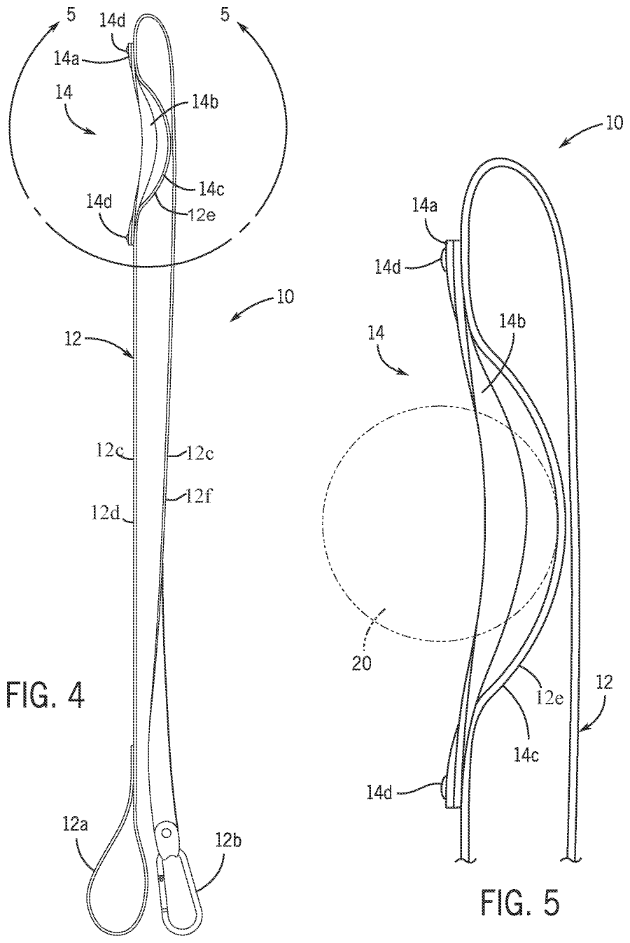

Referring to FIGS. 1 through 5, the present invention may include a pet accessory 10. The pet accessory may comprise a leash 12, and a sling assembly 14. The leash 12 may comprise a handle 12a, and a clip 12b. A main leash body 12c extends between the handle 12a and the clip 12b, and further comprises a proximal leash portion 12d, an intermediate leash portion 12e, and a distal leash portion 12f.

In an exemplary embodiment, the sling assembly 14 may be located on the leash body 12c at the intermediate portion 12e, between the proximal leash portion 12d and the distal leash portion 12e. The sling assembly 14 may comprise an object storage receptacle or ball receptacle. The sling assembly 14 may comprise a first sling component 14a, a second sling component 14b, a third sling component 14c, and sling fasteners 14d. In an exemplary embodiment, the third sling component is integral with the intermediate leash portion 12e. The sling components are constructed and arranged to hold a round or spherical object, such as, for example without limitation, a ball. The sling components 14a-c are constructed and arranged to provide a cup-like area capable of retaining and cradling the spherical object.

The pet accessory 10 may be used for any pet, a nonlimiting example of which is a dog 16. The pet accessory 10 may be attached to a pet collar 16a, which may comprise a leash attachment point 16b. In use, the pet accessory 10 may be removably attached to leash attachment point 16b by clip 12b. It can be seen that clip 12b may be any suitable attachment means made of any suitable material. In one embodiment, a nonlimiting example of clip 12b may be a spring-loaded removable clip or carabiner.

In an exemplary embodiment the components of the present invention may be made of any suitable materials by any suitable fabrication process. In some embodiments, existing leash materials may be used, such as, for example without limitation, nylon webbing. In some embodiments the leash clip may be any suitable clip, nonlimiting examples of which may include a metal clip for attachment of the leash to a pet collar. In some embodiments, the leash handle and sling components may be created by stitching webbing to itself. The leash and sling may be a single unitary length of webbing, or may be made of separate components attached together by sling fasteners. The sling fasteners may be any suitable attachment device, such as, for example without limitation, rivets, bolts, snaps, clips or the like.

Material such as nylon webbing would be necessary for the bulk of the leash and would comprise the majority of the invention. The ball holder area could be made of a multitude of different materials and shape for optimal fit and performance. The leash may be any suitable length.

A user 18 may insert a ball 20 in the sling assembly 14 so that the ball 20 may be retained therein. Further, the user 18 may remove the accessory 10 from attachment to the pet collar 16a, for use of the sling assembly 14 of the pet accessory 10 as a projectile launcher for launching the ball.

In one exemplary embodiment, the handle 12a of the leash 12 may be constructed and arranged to be capable of being slipped over a hand of a user and around a wrist of the user, for stability and comfort.

In use, the leash handle 12a and the leash clip 12b may function in a same or similar manner to a regular pet leash and lead, to allow control of a pet.

In an exemplary embodiment, the pet accessory may be used initially as a dog lead or leash in the standard fashion. When presented with a ball or other spherical device, the pet accessory may be looped onto itself to be used as a shepherd's sling, allowing the user to hurl objects at a considerable distance for the amusement and exercise of the pet.

In an exemplary embodiment, the present invention may comprise a method for use comprising one or more of the following steps and combinations thereof. The pet accessory may be attached to a pet collar by attaching the leash clip 12b to a pet collar 16a at the pet collar leash attachment 16b. The pet accessory 10 may be used as a pet leash and lead to enable the user to control a pet. The pet accessory 10 may be used to store a spherical object by placing the spherical object in the sling assembly 14. The leash may be removed from the pet collar leash attachment for use as a projectile launcher. The leash handle 12a may remain around a wrist of a user for use as the projectile launcher. The user may grasp the clip 12b so that the pet accessory 10 handle 12a and clip 12b are held in close proximity and proximal to the user, so that the leash forms a hanging U-shape with the intermediate leash portion 12e and object or ball storage receptacle (also called ball receptacle) distal from the user. The spherical object which may be a ball, may be placed in the ball receptacle. The leash and sling may then be twirled by the user in a circular pattern using a wrist and arm to create centrifugal force to the ball. At a defined moment, the leash clip 12b may be released by the user. In response to the user releasing the leash clip, the ball is released and is hurled.

In summary, a pet accessory comprising a leash and a receptacle for holding a spherical object is provided. The pet accessory provides a combination pet leash and sling for holding the spherical object which may also be used as a sling to hurl the object. The pet accessory comprising a leash, a sling system and a spherical object receptacle built into the pet accessory is capable of use to hurl a projectile easily without a separate accessory.

It should be understood, of course, that the foregoing relates to exemplary embodiments of the invention and that modifications, variations and changes in detail may be made without departing from the spirit and scope of the invention as set forth in the following claims.

What is claimed is:

1. A pet accessory comprising a leash and a sling assembly.

2. The pet accessory of claim 1 wherein:
the leash further comprises a leash main body, a leash proximal portion, a leash intermediate portion and a leash distal portion;
the leash further comprises a leash handle located at a proximal end of the leash, a leash clip located at a distal end of the leash, and the leash main body extends between the leash handle and the leash clip; and
the sling assembly is located at the leash intermediate portion between the leash proximal portion and the leash distal portion.

3. The pet accessory of claim 2 wherein the sling assembly further comprises an object storage receptacle constructed and arranged to retain a spherical object.

4. The pet accessory of claim 3 wherein the sling assembly further comprises a first sling component, a second sling component, and a third sling component, constructed and arranged to provide a cup-like area capable of retaining and cradling the spherical object.

5. The pet accessory of claim 4 wherein the first sling component, the second sling component and the third sling component are fastened together and to the leash by a plurality of sling fasteners.

6. The pet accessory of claim 4 wherein:
the leash and the sling assembly comprise a unitary construction of a single piece of nylon webbing; and
the single piece of nylon webbing is stitched or sewn together to form the leash, the first sling component, the second sling component, and the third sling component.

7. The pet accessory of claim 5 wherein the third sling component is integral with the intermediate leash portion.

8. A method for using a pet accessory, the method comprising on or more of the following steps and combinations thereof:
providing a pet accessory as set forth in claim 3;
removably attaching the pet accessory to a pet collar;
using the pet accessory as a leash;
removing the pet accessory from the pet collar;
using the pet accessory to store a spherical object; and
using the pet accessory as a projectile launcher.

9. A method for using a pet accessory, the method comprising:
a) providing a pet accessory comprising a leash and a sling assembly, the pet accessory further comprising:
i) a leash main body;
ii) a leash proximal end;
iii) a leash proximal portion;
iv) a leash intermediate portion;
v) a leash distal end; a leash distal portion;
vi) a leash handle located at the leash proximal end; and
vii) a leash clip located at the leash distal end,
wherein the leash main body extends between the leash handle and the leash clip; and
wherein the sling assembly is located at the leash intermediate portion between the leash proximal portion and the leash distal portion and the sling assembly further comprises an object storage receptacle constructed and arranged to retain a spherical object;
b) removably attaching the leash clip to a pet collar on a pet, the pet collar having a pet collar leash attachment to which the leash clip may be attached;
c) using the pet accessory as a pet leash;
d) removing the pet accessory from the pet collar for use as a projectile launcher;
d) providing a spherical object and using the pet accessory to store the spherical object by placing the spherical object in the sling assembly;
e) using the pet accessory as a projectile launcher by:
i) retaining the leash handle around a wrist of a user;
ii) grasping the leash clip so that the leash handle and leash clip are held by the user in close proximity and proximal to the user, so that the pet accessory forms a hanging U-shape with the intermediate leash portion and sling assembly are distal from the user;
iii) placing the spherical object in the sling assembly;
iv) twirling the pet accessory in a circular pattern using a wrist and arm to create centrifugal force to the ball, and at a defined moment, releasing the leash clip,
whereby in response to the user releasing the leash clip, the ball is released and is hurled.
